(19) United States
(12) Patent Application Publication
(10) Pub. No.: US 2019/0329298 A1
(43) Pub. Date: Oct. 31, 2019

(54) APPARATUS AND METHOD FOR SEPARATING METAL PARTICLES

(71) Applicant: MESUTRONIC Gerätebau GmbH, Kirchberg im Wald (DE)

(72) Inventors: Klaus Weindl, Patersdorf (DE); Manfred Artinger, Schönberg (DE)

(73) Assignee: MESUTRONIC Gerätebau GmbH, Kirchberg im Wald (DE)

(21) Appl. No.: 16/394,903

(22) Filed: Apr. 25, 2019

(30) Foreign Application Priority Data
Apr. 26, 2018 (DE) 102018110013.2

(51) Int. Cl. B07C 5/36; B07C 5/344; B65G 53/56; B65G 53/60

(52) U.S. Cl. CPC B07C 5/363; B07C 5/344; B07C 2501/0036; B65G 53/56; B65G 53/60; B07C 5/362

(57) ABSTRACT

An apparatus for separating metal particles from a material stream of a bulk material, comprising a detection device for detecting metal particles in the material stream and a separating device configured to separate a portion of the material stream in which the metal particles are contained, the separating device comprising a housing having a material inlet, a good-material outlet and a bad-material outlet; a rotary piston rotatably mounted in the housing and configured to guide the material stream from the material inlet to the good-material outlet or to the bad-material outlet depending on the detection result of the detection device; a drive unit configured to position the rotary piston at least in a first and a second rotary position; wherein the drive unit is configured to rotate the rotary piston between the first rotary position and the second rotary position by an angle of rotation greater than 90°.

### CROSS-REFERENCE TO RELATED APPLICATION

This application claims the benefit of German Application Number DE 10 2018 110 013.2, filed Apr. 26, 2018, the disclosure of which is hereby incorporated by reference.

### FIELD

The present disclosure relates to an apparatus and a method for separating metal particles from a material stream.

### BACKGROUND

Apparatuses for the separation of metal particles are already known. They comprise a detection device which can be used to detect the presence of a metal particle in the material stream, and a separating device which causes a separation of a portion of the material stream, for example the material located in the separating device and in the detection device.

The publication DE 199 27 368 A1 discloses a separating device with a rotary piston which has a Y-shaped passage channel.

The common separating device is disadvantageous in that the separated material volume is relatively large due to the Y-shaped passage channel, and thus, waste of material is unnecessarily high. In addition, the Y-shape of the rotary piston results in a relatively large overall size.

### SUMMARY

In view of that, an object of the present disclosure is to provide an apparatus with a reduced overall size which enables a material-saving separation of a portion of the material stream.

The object is solved by an apparatus having features disclosed herein. A method for separating a portion of a material stream of a bulk material, which is mixed with at least one metal particle, is also described.

According to a first aspect, an apparatus is described for separating a portion of a material stream of a bulk material, which is mixed with at least one metal particle. The apparatus comprises a detection device for detecting a metal particle in the material stream and a separating device configured to separate a portion of the material stream in which the at least one metal particle is contained. The separating device comprises the following:
a housing having a material inlet, a good-material outlet and a bad-material outlet;
a rotary piston rotatably mounted in the housing and configured to guide the material stream from the material inlet to the good-material outlet or to the bad-material outlet depending on the detection result of the detection device, and
a drive unit configured to position the rotary piston at least in a first and a second rotary position.

The drive unit is configured such that the rotary piston is rotated between the first rotary position and the second rotary position by an angle of rotation greater than 90°.

A substantial advantage of the apparatus is that due to the angle of rotation greater than 90°, a material guiding section, which closes the bad-material outlet in the first rotary position of the rotary piston, can be used to close the good-material outlet in the second rotary position and to simultaneously form a lower inclined guiding surface for the material to be diverted, in order to discharge it via the bad-material outlet due to gravity or at least supported by gravity.

In an embodiment, the angle of rotation is greater than 100°, preferably greater than 110°. This can be achieved with a material guiding section of the rotary piston being inclined such that it enables gravity-supported diversion of the material to be discharged.

In an embodiment, the rotary piston has a material guiding section which closes the bad-material outlet in the first rotary position and closes the good-material outlet in the second rotary position. The material guiding section comprises in particular a continuous rotary piston section which is not penetrated by any passages. The material guiding section is preferably formed planar. On the outside, the material guiding section preferably has a cylinder-segment-shaped outer contour. The inner wall section of the material guiding section which guides the material is preferably curved concavely, in order to enable, in the first rotary position, together with the housing a tubular passage of the material through the separating device. With this shape of the material guiding section, a separation of the material mixed with at least one metal particle can be achieved with as little material loss as possible.

In an embodiment, the rotary piston comprises a material guiding section which has an inclined position in the second rotary position, in order to feed the portion of the material stream to be separated to the bad-material outlet in a chute-like manner. In other words, the material guiding section has a position inclined in a direction towards the bad-material outlet, so that the portion of the material stream to be separated is discharged via the bad-material outlet supported by gravity. Thus, the separation process is considerably facilitated and shortened.

In an embodiment, the rotary piston has disc-shaped front and rear piston sections and a concave material guiding section interconnecting the front and rear piston sections. The front and rear piston sections can significantly reduce the dead space within the passage channel of the separating device in which material may come to rest. The material guiding section is preferably formed as a continuous planar section without passages, so that the rotary piston can be moved as quickly as possible and with low torque from the first rotary position to the second rotary position and vice versa.

In an embodiment, the rotary piston has no passages which are tubular, essentially tubular or formed completely closed at the circumference. The switch-like diversion of a portion of the material stream to the bad-material outlet is therefore not effected by rotating a tubular diversion device, but by shifting a planar material guiding section.

In an embodiment, discharge supporting means are provided which accelerate the separation of the portion of the material stream. The discharge supporting means can in particular cause the material to be blown out across the bad-material outlet or to be sucked off to the bad-material outlet. Thus, the material diversion process can be shortened.

In an embodiment, the discharge supporting means comprise a compressed air nozzle, a venturi nozzle or a suction device. Preferably, a compressed air nozzle is used as this allows a quicker and more efficient discharge of the material.

In an embodiment, the compressed air nozzle is configured to generate within the housing an air stream which is directed towards the bad-material outlet. The direction of the air stream can, for example, at least substantially correspond to the axial direction of the bad-material outlet. Thus, a very efficient discharge of material can be carried out.

In an embodiment, the drive unit is a pneumatic drive. By means of a pneumatic drive, on the one hand a high torque for the rotary movement of the rotary piston can be obtained, and on the other hand very fast switching operations between the respective rotary positions can be achieved.

In an embodiment, the drive unit has at least one gear rack actuated by a pneumatic actuator, wherein a mechanism is provided which converts a translational movement of the gear rack into a rotary movement of the rotary piston. The mechanism may have a gear wheel, for example, which engages the at least one gear rack. Thus, a drive with high torque and fast switching times can be realized, in particular with switching times smaller than 50 ms.

In an embodiment, the drive unit comprises a pair of gear racks driven in opposite directions. By using several gear racks and several pneumatic actuators, the torque applied to the rotary piston can be increased and the switching times can be further reduced.

In an embodiment, the compressed air nozzle can be supplied with compressed air via the drive unit. In detail, a pneumatic actuator not only applies a torque to the rotary piston, but also forms a compressed air valve which controls the supply of compressed air to the compressed air nozzle. In particular, a piston provided in the pneumatic actuator can, in an end position, unblock a hole which can cause a supply of compressed air to the compressed air nozzle. This increases the operating safety of the device and reduces the complexity of the device, since the function of a compressed air valve is taken over by the pneumatic actuator.

In an embodiment, a bypass line is provided which connects the pneumatic actuator with the compressed air nozzle such that the compressed air nozzle can be supplied with compressed air via the pneumatic actuator when the rotary piston is in the second rotary position. In this manner, the pneumatic actuator also functionally forms a compressed air valve for the selective supply of compressed air to the compressed air nozzle.

In an embodiment, compensating means are provided which may be used to compensate for the displacement of a volume of bulk material caused by the rotation of the rotary piston. This enables a decisive reduction of the torque required to rotate the rotary piston, in particular the torque required to initiate the rotary motion.

In an embodiment, the compensating means comprise a spring-loaded piston. The piston can be pushed back against the spring force when the rotation of the rotary piston is initiated. When the bad-material outlet is at least partially unblocked, the pressure on the piston is reduced so that the piston is moved back to its initial position by the spring force.

Alternatively, the compensating means may comprise a material portion made of an elastic material or an otherwise reversibly deformable material, such as foam.

In an embodiment, the rotary piston can be removed from the housing without tools. For example, the rotary piston can be removed from the housing after removing a cover, which is fixed to the housing by means of manually operated screws or nuts, for example. Thereby, the transmission of torque to the rotary piston can be realized by means of a form-fit plug connection which is releasable by pulling out the piston along its axis of rotation, and which is restorable by inversely inserting the same. This makes the device easy to clean, which is particularly necessary when changing the conveyed material.

According to a further aspect, a method is described for separating a portion of a material stream of a bulk material, which is mixed with at least one metal particle, by means of a separating device. The method comprises the following steps:
detecting a metal particle in a material stream of a bulk material;
rotating a rotary piston of the separating device from a first rotary position to a second rotary position for unblocking a bad-material outlet, in order to divert a portion of the material stream containing the at least one metal particle via the bad-material outlet, wherein the rotary piston is rotated between the first rotary position and the second rotary position by an angle of rotation greater than 90°.

The term “good-material outlet” as used herein means a material outlet through which material that does not contain any metal particles is delivered. The good-material outlet thus represents the standard outlet through which the material is discharged when no metal particle can be detected.

The term “bad-material outlet” as used herein means a material outlet through which material containing at least one metal particle is delivered. The bad-material outlet thus represents the outlet through which a portion of a material stream is discharged when at least one metal particle has been detected in this portion.

The expressions “approximately”, “substantially” or “about” as used herein mean deviations from the exact value by +/−10%, preferably by +/−5% and/or deviations in the form of changes that are insignificant for the function.

Further developments, advantages and possible applications of the present disclosure can be derived also from the following description of embodiments and from the drawing figures.

### BRIEF DESCRIPTION OF THE DRAWINGS

The invention is explained in more detail below with respect to embodiments and based on the drawing figures. In the drawing figures:

FIG. 1 shows an embodiment of a detection and separating apparatus in a perspective front view;

FIG. 2 shows an embodiment of a detection and separating apparatus in a perspective rear view;

FIG. 3 shows, as an example, an embodiment of a detection and separating apparatus according to FIG. 1 in a partial exploded view;

FIG. 4 shows, as an example, a perspective view of the rotary piston;

FIG. 5 shows, as an example, the separating device with removed rotary piston in isolated position and in perspective view;

FIG. 6 shows, as an example, the separating device in a lateral view;

FIG. 7 shows, as an example, the separating device with the rotary piston in a first rotary position (basic position) in a sectional view along the cutting line A-A in FIG. 6;

FIG. 8 shows, as an example, the drive unit of the separating device with the rotary piston in the first rotary position (basic position) in a sectional view along the cutting line B-B in FIG. 6;

FIG. 9 shows, as an example, the separating device with the rotary piston in a second rotary position (separating position) in a sectional view along the cutting line A-A in FIG. 6;

FIG. 10 shows, as an example, the drive unit of the separating device with the rotary piston in the second rotary position (separating position) in a sectional view along the cutting line B-B in FIG. 6;

### DETAILED DESCRIPTION

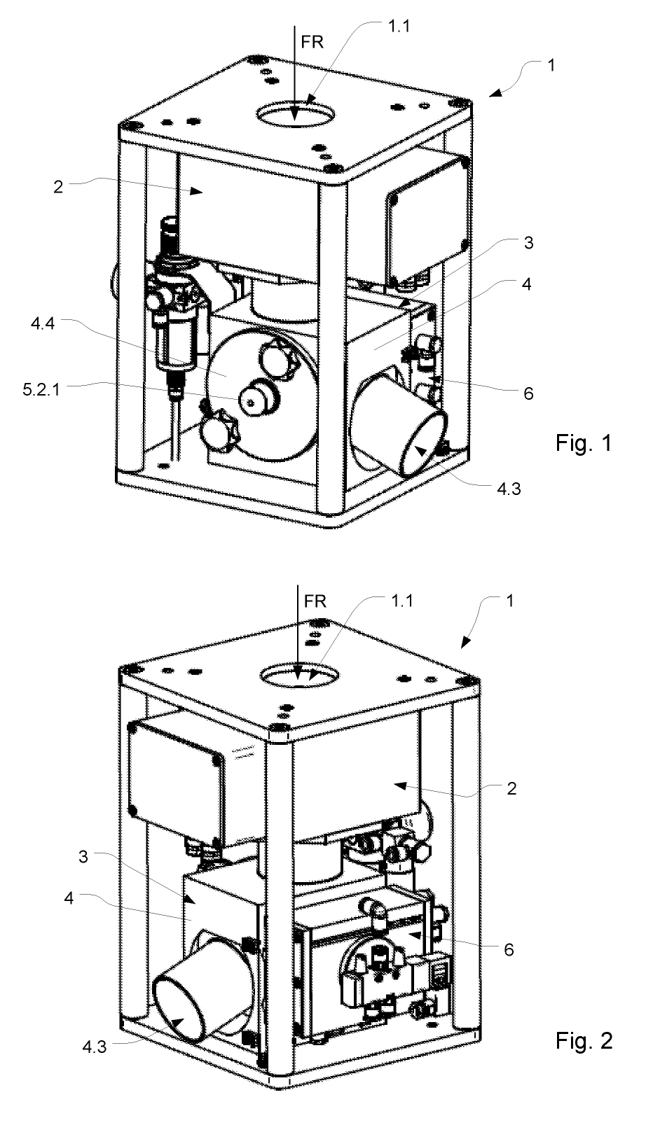

FIGS. 1 and 2 show a detecting and separating apparatus 1, hereinafter shortly referred to as apparatus 1, in perspective front and rear views.

Apparatus 1 is configured to examine a material stream of a bulk material for metal particles contained therein, and to separate a portion of the material stream in which at least one metal particle is contained so that the metal particle is removed from the material stream. Any powder material or free-flowing material can be used as bulk material, in particular plastic granules or plastic flakes, as used in injection moulding machines or extruders in plastics processing. It is clear, however, that apparatus 1 is not limited to this field of application and generally can also be used to separate metal particles from other material streams.

Apparatus 1 comprises a feed opening 1.1 through which the material stream is fed to apparatus 1 in a conveying direction FR. In conveying direction FR downstream of the feed opening 1.1, a detection device 2 is provided which can be used to detect metal particles contained in the material stream. Detection device 2 may in particular comprise a detection coil which circumferentially surrounds an area through which the material stream is conveyed. In addition, detection device 2 can include evaluation electronics which evaluate the electrical signal provided by the detection coil. The evaluation electronics can be an integral part of apparatus 1 or may be merely coupled to apparatus 1.

In conveying direction FR downstream of the detection device 2, the apparatus 1 comprises separating device 3 which, based on the evaluation information provided by the detection device 2, causes a diversion of a portion of the material stream in which the at least one metal particle is contained.

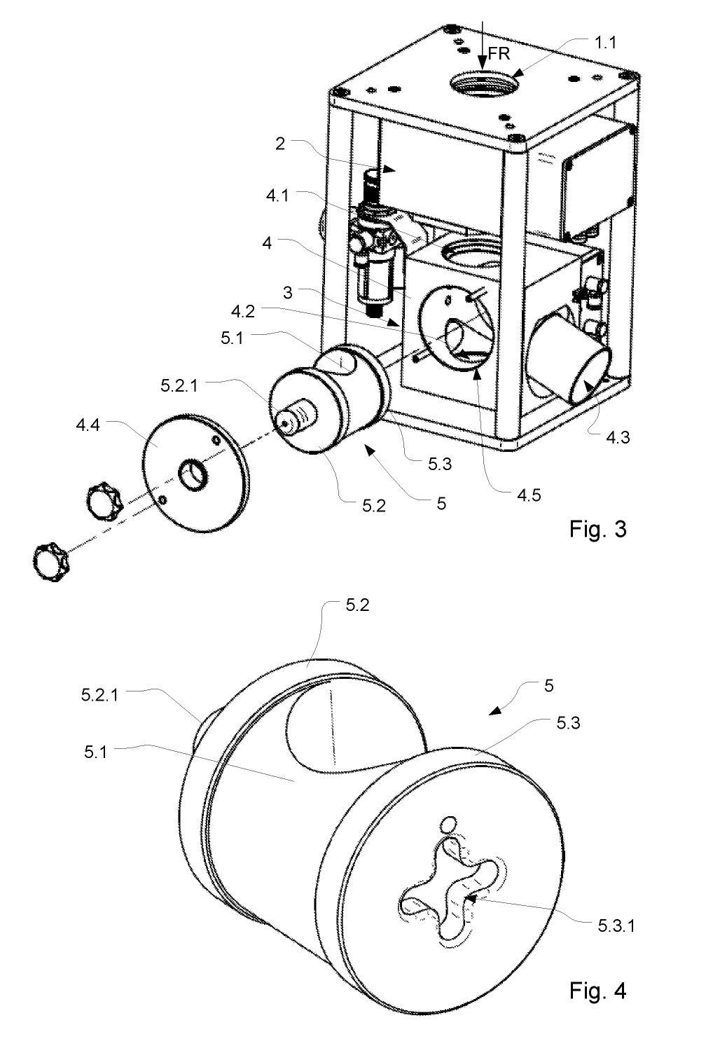

As can be seen in particular in the exploded view shown in FIG. 3, separating device 3 comprises a housing 4 within which a rotary piston 5 is rotatably mounted. Housing 4 comprises a material inlet 4.1, a good-material outlet 4.2 and a bad-material outlet 4.3. In addition, housing 4 comprises a recess 4.5 which is circular or substantially circular in cross-section and into which a rotary piston 5 can be inserted. Good-material outlet 4.2 forms the desired or regular material outlet through which the bulk material conveyed by the separating device 3 exits when no metal particles have been detected in the material stream by detection device 2. Through bad-material outlet 4.3, on the other hand, a portion of the material stream is separated when one or more metal particles have been detected in the material stream by detection device 2. Thus, separating device 3 forms a kind of switch which can be used to direct the material stream either to good-material outlet 4.2 or to bad-material outlet 4.3.

Switching of the discharge of the conveyed material from good-material outlet 4.2 to bad-material outlet 4.3 or vice versa is effected by rotating rotary piston 5. In a first rotary position of rotary piston 5, hereinafter also referred to as the basic position, bad-material outlet 4.3 is closed by a material guiding section of rotary piston 5 and good-material outlet 4.2 is unblocked. Conversely, bad-material outlet 4.3 is unblocked in a second rotary position of rotary piston 5, hereinafter referred to as the separating position, and good-material outlet 4.2 is closed by a material guiding section of rotary piston 5.

Good-material outlet 4.2 is preferably arranged opposite to material inlet 4.1, in particular diametrically opposite. Bad-material outlet 4.3 is arranged before good-material outlet 4.2 with respect to the direction of rotation of rotary piston 5 during the switching between the basic position and the separating position, i.e., between material inlet 4.1 and good-material outlet 4.2 when looking in the direction of rotation of rotary piston 5. The axial direction of bad-material outlet 4.3 preferably extends obliquely relative to a vertical yaw axis and preferably includes an angle of less than 90°, preferably an angle between 50° and 80°, in particular between 60° and 70°, with this yaw axis, wherein the angle is opening downwards in the direction towards good-material outlet 4.2.

For rotating rotary piston 5, a drive unit 6 is provided which can be used to position rotary piston 5 in the basic position or in the separating position. Drive unit 6 is preferably a pneumatically operated drive unit. Thus, a high switching speed and a high torque at rotary piston 5 can be effectuated.

In particular, but not only, in plastics processing, it may be necessary for separating device 3 to be easy to clean, for example when changing the bulk material to be processed or when changing colour. Separating device 3 is designed such that rotary piston 5 can be removed from housing 4 without tools, as shown in FIG. 3.

In the depicted embodiment, housing 4 can be closed at the front with a cover 4.4 which can be fixed to housing 4 by means of manually operated nuts, in particular knurled nuts or similar, for example. Upon removal of cover 4.4, rotary piston 5 can be pulled out of housing 4 in axial direction (relative to the rotary axis of rotary piston 5). Thus, the interior of separating device 3 can be cleaned efficiently and in a time-saving manner. Cover 4.4 may have a bearing position for rotary piston 5.

FIG. 4 shows rotary piston 5 in the dismounted state in a detailed perspective view. Rotary piston 5 comprises a rotary piston front section 5.2, a rotary piston rear section 5.3 and a material guiding section 5.1 which is arranged between the front and rear rotary piston sections 5.2, 5.3 and by which the rotary piston sections 5.2, 5.3 are interconnected. The front and rear rotary piston sections 5.2, 5.3 are formed with circular cross-section. The diameter of the rotary piston sections 5.2, 5.3 is adapted to the diameter of recess 4.5 formed in housing 4 in which rotary piston 5 is inserted.

Rotary piston front section 5.2 preferably has a protrusion 5.2.1 protruding in the direction of the axis of rotation, which serves to support the rotary piston in a bearing position provided in cover 4.4 and serves as a handle element for pulling rotary piston 5 out of housing 4.

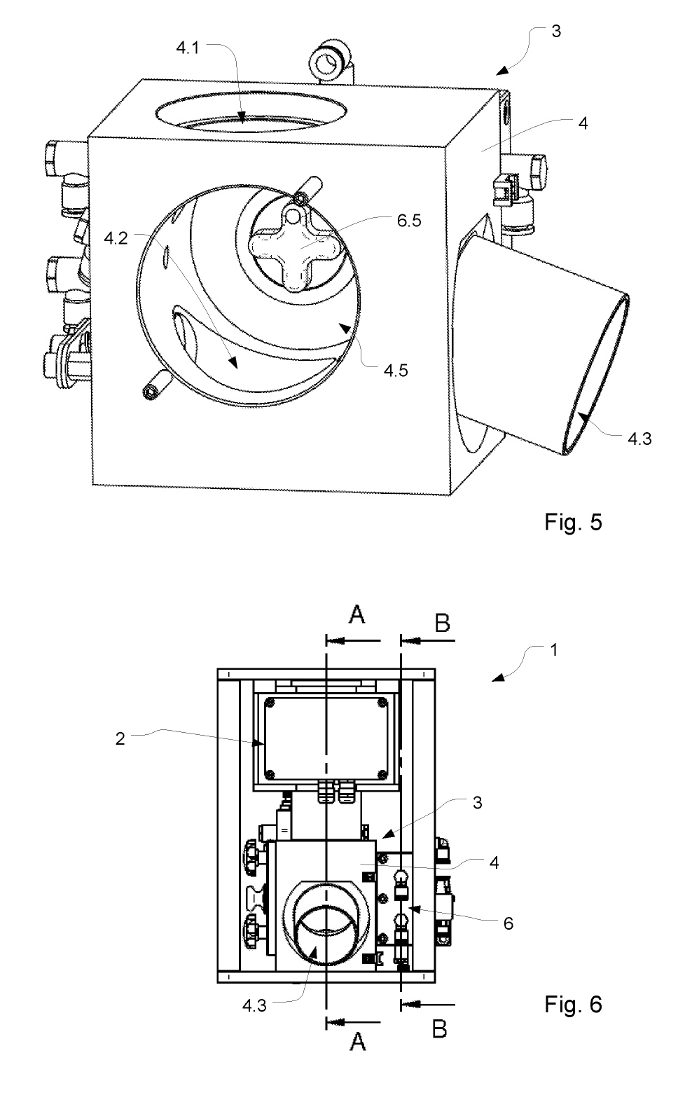

A contour 5.3.1 is provided at the rotary piston rear section 5.3. This contour 5.3.1 preferably cooperates with an inverse drive contour 6.5 of drive unit 6 (see FIG. 5) in order to transmit a torque from drive unit 6 to the rotary piston. Preferably, drive contour 6.5 engages positively in contour 5.3.1. In the depicted embodiment, contour 5.3.1 comprises a recess in rotary piston rear section 5.3, in particular a cross-shaped contour.

In order to prevent rotary piston 5 from being installed in the housing in a wrong rotational position, rotary piston 5 can be designed such that rotary piston 5 can be inserted completely into housing 4 only in a single rotational position. This can be achieved, for example, by a rotation proof form-fit between drive contour 6.5 and contour 5.3.1.

As shown in FIG. 3 and FIG. 4, material guiding section 5.1 is formed from a one-piece wall section, which is preferably formed by milling out a cylindrical solid. Here “one-piece” means that material guiding section 5.1 does not have several regions between which, for example, a circumferentially closed passage is formed for the material to be conveyed. Rather, material guiding section 5.1 comprises a single, web-like section of the rotary piston, which is used to close good-material outlet 4.2 or bad-material outlet 4.3, depending on the rotary position of rotary piston 5.

Material guiding section 5.1 has an inner wall portion along which the conveyed material is conveyed. This wall portion is preferably curved concavely, so that in the basic position of rotary piston 5 the material stream can be conveyed from material inlet 4.1 in the direction towards good-material outlet 4.2 without or substantially without any tapering of the cross-section. The edges of material guiding section 5.1 are preferably sharp-edged, in order to allow reduction of the torque required for rotating rotary piston 5.

The shape of rotary piston 5 or drive unit 6, respectively, is formed such that rotary piston 5 is rotated by an angular amount greater than 90°, in particular greater than 100° or 110°, when switching between the basic position and the separating position or vice versa. This ensures that rotary piston 5 is brought from the basic position, in which bad-material outlet 4.3 is closed, to a rotary position in which good-material outlet 4.2 is closed, bad-material outlet 4.3 is opened and material guiding section 5.1 forms a chute-like guiding section towards bad-material outlet 4.3. “Chute-like” here means that the diversion of material occurs supported by gravity.

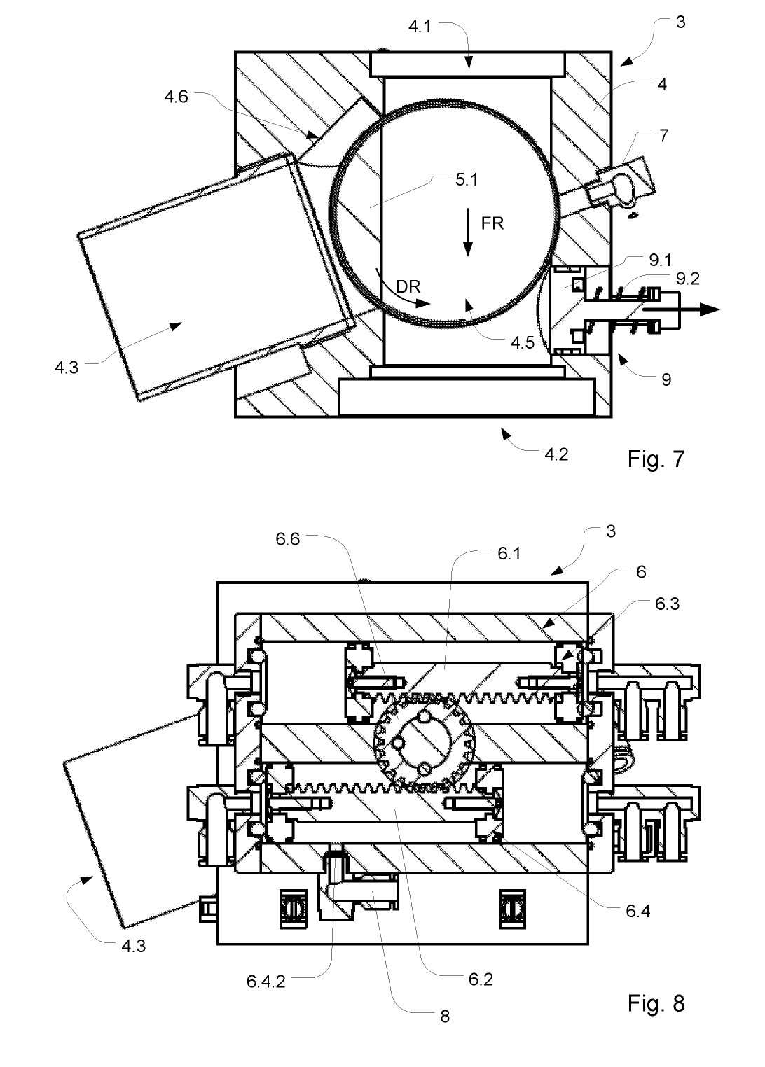

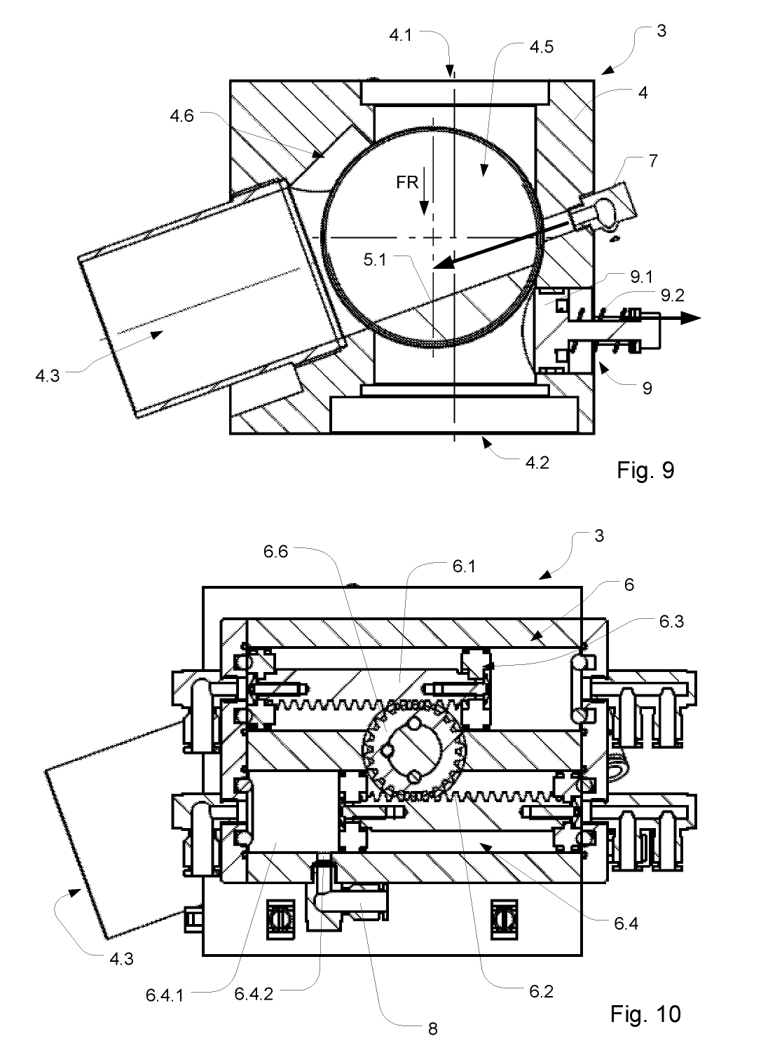

FIGS. 7 and 8 or FIGS. 9 and 10 each show longitudinal sections through housing 4 of separating device 3 or drive unit 6, respectively, namely FIGS. 7 and 9 along cutting line A-A shown in FIG. 6, and FIGS. 8 and 10 along cutting line B-B shown in FIG. 6.

FIGS. 7 and 8 show rotary piston 5 and drive unit 6 driving rotary piston 5 in the basic position. Here, bad-material outlet 4.3 is completely closed by material guiding section 5.1 of rotary piston 5, and in housing 4, a passage area having a continuously homogeneous cross-section or an essentially homogeneous cross-section is created in the region of recess 4.5. Thus, dead spaces can be avoided.

In FIGS. 9 and 10, rotary piston 5 is in the separating position. The separating position is achieved by rotating rotary piston 5 in the direction of rotation DR shown in FIG. 7, so that bad-material outlet 4.3 is unblocked and good-material outlet 4.2 is completely closed by material guiding section 5.1.

As previously mentioned, the rotation is effected with an angular amount greater than 90°, so that material guiding section 5.1 forms a chute-like sliding surface in the direction towards bad-material outlet 4.3. Thus, the diversion of the portion of the material stream containing one or more metal particles can occur supported by gravity.

Preferably, discharge supporting means are provided which can be used to improve or accelerate the discharge of a portion of the material stream. In the depicted embodiment, a compressed air nozzle 7 is provided, through which the material in recess 4.5 can be exposed to compressed air (see arrow in FIG. 9) when rotary piston 5 is positioned in the separating position. This can significantly accelerate the discharge of material and shorten the separation process. Compressed air nozzle 7 is preferably arranged opposite to bad-material outlet 4.3. The ejection direction of the compressed air nozzle 7 is preferably directed towards bad-material outlet 4.3.

Alternatively or additionally to the application of compressed air, the material discharge can also be improved or accelerated by applying a suction effect to bad-material outlet 4.3. The suction effect can be effectuated by a suction device, such as a venturi nozzle.

In the following, the structure of drive unit 6 is described with respect to the embodiment shown in FIGS. 8 and 10. Drive unit 6 comprises a pair of gear racks 6.1, 6.2 which are operatively connected to a gear wheel 6.6. In an alternative embodiment, only a single gear rack can be provided, especially if lower torques are required or longer switching times are acceptable. Gear racks 6.1, 6.2 are provided opposite to each other with respect to the axis of rotation of gear 6.6, for example gear rack 6.1 above gear 6.6 and gear rack 6.2 below the same. Preferably, gear racks 6.1, 6.2 extend parallel or essentially parallel to each other.

Gear racks 6.1, 6.2 are operatively connected to pneumatic actuators 6.3, 6.4. In particular, pneumatic actuators 6.3, 6.4 are pneumatic cylinders which can be used to effectuate a translational movement of gear racks 6.1, 6.2. Pneumatic actuator 6.3 is preferably in operative connection with gear rack 6.1, and pneumatic actuator 6.4 preferably with the gear rack 6.2. Pneumatic actuators 6.3, 6.4 preferably cause a displacement move in opposite directions at gear racks 6.1, 6.2. Due to the engagement of the teeth of gear racks 6.1, 6.2 with the corresponding teeth of gear wheel 6.6, the translational movement of gear racks 6.1, 6.2 can be converted into a rotational movement of gear wheel 6.6. Gear wheel 6.6 is thereby operatively connected to drive contour 6.5, in order to drive rotary piston 5 via gear wheel 6.6.

FIG. 8 shows the positioning of gear racks 6.1, 6.2 and pneumatic actuators 6.3, 6.4 when rotary piston 5 is in the basic position. FIG. 10 on the other hand shows the positioning of gear racks 6.1, 6.2 and pneumatic actuators 6.3, 6.4 when rotary piston 5 is in the separating position. One or both pneumatic actuators 6.3, 6.4 may have means for monitoring the position of the piston contained in the pneumatic actuator. It is thus possible to monitor either only one position (e.g., where rotary piston 5 is in the basic position) or both positions, i.e., both the position of the piston where rotary piston 5 is in the basic position and the position of the piston where rotary piston 5 is in the separating position.

As shown in FIG. 8 and FIG. 10, the supply of compressed air to compressed air nozzle 7 is controlled via at least one of pneumatic actuators 6.3, 6.4, in the present embodiment pneumatic actuator 6.4. For this purpose, pneumatic actuator 6.4 is coupled to compressed air nozzle 7 via a bypass line 8.

Bypass line 8 is connected to cylinder interior 6.4.1 of pneumatic actuator 6.4. For this purpose, a hole 6.4.2 is provided in the wall confining cylinder interior 6.4.1, through which compressed air is conducted via bypass line 8 in the direction towards compressed air nozzle 7 when the piston of pneumatic actuator 6.4 is in an end position, which is assumed in the separating position of rotary piston 5.

As can be seen in a combined view of FIGS. 8 and 10, hole 6.4.2 is arranged such that hole 6.4.2 is not applied with compressed air in the basic position of rotary piston 5, and application of compressed air occurs only when rotary piston 5 has taken the separating position or essentially the separating position, i.e. not in the basic position of rotary piston 5. Thus, pneumatic actuator 6.4 simultaneously controls the supply of compressed air to compressed air nozzle 7.

Alternatively, the supply of compressed air to compressed air nozzle 7 can also be effected via a compressed air valve which controls the supply of compressed air to compressed air nozzle 7 such that compressed air is supplied to compressed air nozzle 7 only when rotary piston 5 is in the separating position.

In the event that rotary piston 5 is located in the basic position, the recess from material inlet 4.1 to good-material outlet 4.2 is completely filled with the material to be conveyed. When rotating rotary piston 5 from the basic position to the separating position, material guiding section 5.1 of rotary piston 5 must be moved into the material.

In particular with granulates or flakes as material to be conveyed, a very high torque is required for turning rotary piston 5.

To enable torque-reduced rotation of rotary piston 5 from the basic position to the separating position, compensating means 9 are provided. With the compensating means, a volume is temporarily released into which a portion of the material located in recess 4.5 can be displaced when rotating rotary piston 5. Thus, blocking of rotary piston 5 can be prevented, since the material displaced by material guiding section 5.1 during the rotation can be shifted into the released volume. When the rotary piston has completed a partial rotation, the initially displaced material is pushed back into recess 4.5 by compensating means 9, so that it can then also be discharged via bad-material outlet 4.3.

In the embodiment shown, compensating means 9 comprise a piston 9.1 which is biased to a position advanced by a spring 9.2 in the direction towards bad-material outlet 4.3. Thus, in the position of piston 9.1 shown in FIGS. 7 and 9, no additional volume is released in recess 4.5.

When rotary piston 5 is rotated from the position shown in FIG. 7 to the position shown in FIG. 9, the material displaced by material guiding section 5.1 during the rotation exerts a force on piston 9.1, and piston 9.1 is pushed back in the direction away from bad-material outlet 4.3 (see arrow in FIG. 7). Due to the spring load on piston 9.1, it is pushed back to the basic position shown in FIGS. 7 and 9 when bad-material outlet 4.3 is at least partially unblocked by material guiding section 5.1.

In order to enable a separation of material at bad-material outlet 4.3 as soon as possible after the rotary motion of rotary piston 5 has been initiated, recess 4.5 may have a cut-out 4.6. Into this cut-out 4.6, material to be separated can enter even after a slight rotation of rotary piston 5, for example after a rotation of 10° or less. Thus, a rapid relief of compensating means 9 and, in particular, a rapid return movement of piston 9.1 into its basic position can be achieved.

In alternative embodiments, compensating means 9 also may comprise other devices, for example reversibly deformable material portions in the region of recess 4.5, such as elastomers, foam-like materials, etc.

The invention was described above based on embodiments. It is clear that numerous amendments and modifications are possible without deviating from the inventive idea underlying the invention and defined by the claims.

### LIST OF REFERENCE SIGNS

1 detecting and separating apparatus

1.1 feed opening

2 detection device

3 separating device

4 housing

4.1 material inlet

4.2 good-material outlet

4.3 bad-material outlet

4.4 cover

4.5 recess

4.6 cut-out

5 rotary piston

5.1 material guiding section

5.2 front piston section

5.2.1 protrusion

5.3 rear piston section

5.3.1 contour

6 drive unit

6.1 first gear rack

6.2 second gear rack

6.3 first pneumatic actuator

6.4 second pneumatic actuator

6.4.1 cylinder interior 6.4.2 hole

6.5 drive contour

6.6 gear wheel

7 compressed air nozzle

8 bypass line

9 compensating means

9.1 piston

9.2 spring

DR direction of rotation

FR conveying direction

1. An apparatus for separating a portion of a material stream of a bulk material which is mixed with at least one metal particle, comprising a detection device for detecting a metal particle in the material stream and a separating device which is configured to separate a portion of the material stream in which the at least one metal particle is contained, wherein the separating device comprises the following:
a housing having a material inlet, a good-material outlet and a bad-material outlet;
a rotary piston rotatably mounted in the housing and configured to guide the material stream from the material inlet to the good-material outlet or to the bad-material outlet depending on the detection result of the detection device;
a drive unit configured to position the rotary piston at least in a first and a second rotary position;
wherein the drive unit is configured to rotate the rotary piston between the first rotary position and the second rotary position by an angle of rotation greater than 90°.

2. The apparatus according to claim 1, wherein the angle of rotation is greater than 100°, preferably greater than 110°.

3. The apparatus according to claim 1, wherein the rotary piston comprises a material guiding section configured to close the bad-material outlet in the first rotary position and to close the good-material outlet in the second rotary position.

4. The apparatus according to claim 1, wherein the rotary piston comprises a material guiding section which has an inclined position in the second rotary position, in order to feed the portion of the material stream to be separated in a chute-like manner to the bad-material outlet.

5. The apparatus according to claim 1, wherein the rotary piston comprises disc-shaped front and rear piston sections and a concavely formed material guiding section interconnecting the front and rear piston sections.

6. The apparatus according to claim 1, wherein the rotary piston has no tubular, substantially tubular or circumferentially completely closed passages.

7. The apparatus according to claim 1, wherein discharge supporting means are provided configured to accelerate the separation of the portion of the material stream.

8. The apparatus according to claim 7, wherein the discharge supporting means comprise a compressed air nozzle, a venturi nozzle or a suction device.

9. The apparatus according to claim 8, wherein the compressed air nozzle is configured to generate in the housing an air stream directed towards the bad-material outlet.

10. The apparatus according to claim 1, wherein the drive unit is a pneumatic drive.

11. The apparatus according to claim 1, wherein the drive unit comprises at least one gear rack actuated by a pneumatic actuator, and a mechanism is provided which is configured to convert a translational movement of the gear rack into a rotary movement of the rotary piston.

12. The apparatus according to claim 1, wherein the drive unit comprises a pair of gear racks driven in opposite directions.

13. The apparatus according to claim 8, wherein the compressed air nozzle can be supplied with compressed air via the drive unit.

14. The apparatus according to claim 13, wherein a bypass line is provided which connects the pneumatic actuator to the compressed air nozzle such that the compressed air nozzle can be supplied with compressed air via the pneumatic actuator when the rotary piston is in the second rotary position.

15. The apparatus according to claim 1, wherein compensating means are provided which are configured to compensate a displacement of a bulk material volume caused by the rotation of the rotary piston.

16. The apparatus according to claim 15, wherein the compensating means comprise a spring-loaded piston.

17. The apparatus according to claim 1, wherein the rotary piston can be removed from the housing without tools.

18. A method for separating a portion of a material stream of a bulk material, which is mixed with at least one metal particle, by means of a separating device, comprising the following steps:
detecting a metal particle in the material stream of the bulk material;
rotating a rotary piston of the separating device from a first rotary position to a second rotary position for unblocking a bad-material outlet, in order to divert the portion of the material stream containing the at least one metal particle via the bad-material outlet, wherein the rotary piston is rotated between the first rotary position and the second rotary position by an angle of rotation greater than 90°.
